(19) United States
(12) Patent Application Publication
(10) Pub. No.: US 2002/0178003 A1
(43) Pub. Date: Nov. 28, 2002

(54) Method and apparatus for providing voice recognition service to a wireless communication device

(75) Inventors: James K. Gehrke, Lake in the Hills, IL (US); Terry Mansfield, Palatine, IL (US); Richard A. Rose, Hoffman Estates, IL (US)

Correspondence Address: MOTOROLA, INC., 1303 EAST ALGONQUIN ROAD, IL01/3RD, SCHAUMBURG, IL, 60196

(73) Assignee: MOTOROLA, INC.

(21) Appl. No.: 09/802,630

(22) Filed: Mar. 9, 2001

(51) Int. Cl. G10L 15/00

(52) U.S. Cl. 704/246

(57) ABSTRACT

A wireless communication system employs a method and apparatus for providing voice recognition service to a wireless communication device. Voice recognition information (e.g., a context model and voice training parameters) is generated by a wireless device user and stored in a memory (e.g., a SIM card) of the wireless device to form one portion of a voice recognition processing engine. Another portion of the voice recognition processing engine (e.g., a voice recognition processor and operating software therefor) is implemented in a wireless system infrastructure of the wireless communication system. The wireless device transmits the voice recognition information to the system infrastructure preferably upon request for such information by the system infrastructure. The system infrastructure then uses both portions of the voice recognition processing engine to provide voice recognition service to the wireless device and its user during operation of the wireless device.

### FIELD OF THE INVENTION

The present invention relates generally to wireless communication systems and, in particular, to a method and apparatus for providing voice recognition service to a wireless communication device operating in a wireless communication system.

### BACKGROUND OF THE INVENTION

Wireless communication systems are well known. Such systems include, but are not limited to, cellular communication systems operating in accordance with various promulgated radio access technologies, such as Advanced Mobile Phone Service (AMPS), Narrowband Advanced Mobile Phone Service (NAMPS), United States Digital Cellular (USDC), Global Systems for Mobile Communications (GSM), and Code Division Multiple Access (CDMA), personal communication systems (PCS) operating in accordance with various radio access technologies, such as CDMA, and multi-service systems, such as the “MOTOROLA” “iDEN” system, that provide many other services in addition to person-to-person calling, such as packet data, paging, short message service, and wireless Internet access. Many PCS operators are also entering the wireless Internet access arena.

To help facilitate hands-free operation of wireless communication devices, such as radiotelephones or two-way radios, operating on such systems, some systems and/or communication devices provide voice recognition service and/or functionality. To provide voice recognition capability, a hardware and software voice recognition processing engine, such as the IBM Voice Type Application Factory for Windows voice recognition processor and accompanying software that is commercially available from International Business Machines Corporation of Armonk, N.Y., must be trained to recognize commands or instructions spoken by each user for which the system or device will be providing voice recognition service. Typically, a user-defined vocabulary (commonly referred to as a “context model”) is established and associated with the user's speech during a setup phase of the voice recognition engine. The size or scope of the context model that can be supported depends upon how the voice recognition engine is implemented.

In the prior art, voice recognition in wireless systems is either completely infrastructure-based or completely device-based. That is, all the voice recognition hardware and software resides either in the wireless system infrastructure (e.g., in a mobile switching center (MSC) of a cellular system) or in the wireless communication device itself. When voice recognition is implemented completely in the system infrastructure, a high power processing system may be employed that is capable of supporting relatively large context models for individual wireless device users. Since the wireless system infrastructure is shared by many users or subscribers, the cost of providing a high power voice recognition processing system is typically recovered through incremental service fees charged to many device users. Therefore, each user incurs a relatively small expense for voice recognition service.

On the other hand, incorporating a high performance voice recognition processing system (processor and memory capacity) directly into a wireless device is typically cost-prohibitive. Consequently, lower power voice recognition processing systems are typically incorporated in wireless devices. Such lower power voice recognition systems are costly enough (typically ten to twenty percent (10-20%) of the cost of the wireless device for the additional memory and computational power), reduce battery life, and only support a very limited context model or instruction set. For example, a voice recognition system completely incorporated in a wireless device typically only facilitates telephone calls based on a single format, such as speaking the digits of a target telephone number or speaking a moderate number (e.g., ten to twenty) of voice-recognizable sound signatures (e.g., names) that may be used to represent specific target telephone numbers. When sound signatures are accommodated, each sound signature is identified during voice recognition training and is associated with a target telephone number that is entered into and stored by the wireless device. Once the voice recognition system is trained, the user can say the name or identity of the stored sound signature and an instruction from a small instruction set (which quite likely includes only a “Call” instruction). For example, the voice recognition system, when trained, may recognize “Call [Target Name from Stored Set]”. The system, when trained, may also recognize the numbers “Zero” through “Nine” to facilitate digit dialing, but that is about the extent of the voice recognition service provided by completely device-based voice recognition systems due to the wireless device's cost-limited processing capabilities.

Although each of the two aforementioned voice recognition system implementations provides at least some voice recognition capability for wireless device users, the two implementations suffer from certain undesirable limitations. For example, although the completely infrastructure-based voice recognition system supports a large context model for each wireless device user, voice recognition may be used by a wireless device user only when the user is operating his or her wireless device in the wireless system containing the user's context model. Since the voice recognition system is completely infrastructure-based, all the hardware and software, including the context models and any user-specific training parameters, are stored in infrastructure memory (e.g., in a home location register (HLR) or some other database associated with the voice recognition system). Thus, if a wireless device user roams to a different wireless system, the user cannot use the voice recognition feature even though the new system may support voice recognition, unless the user goes through the process of training the new voice recognition system and storing his or her context model in the new system. A completely device-based voice recognition system enables voice recognition functionality to travel with the device, but at increased device cost and with much more limited voice recognition capabilities as compared to an infrastructure-based system.

Therefore, a need exists for a method and apparatus for providing voice recognition service to a wireless communication device that provide the benefits of both completely infrastructure-based and completely device-based voice recognition systems, without their respective disadvantages.

### BRIEF DESCRIPTION OF THE DRAWINGS

FIG. 1 is a block diagram of a wireless communication system in accordance with the present invention.

FIG. 2 is a block diagram of a wireless communication device in accordance with a preferred embodiment of the present invention.

FIG. 3 is a block diagram of an arrangement for generating and storing voice recognition information in accordance with a preferred embodiment of the present invention.

FIG. 4 illustrates an exemplary voice recognition information database stored in a memory of a wireless system infrastructure in accordance with a preferred embodiment of the present invention.

FIG. 5 is a logic flow diagram of steps executed to provide voice recognition functionality to a wireless communication device in accordance with one embodiment of the present invention.

FIG. 6 is a logic flow diagram of steps executed by a wireless communication device to enable a wireless system infrastructure to provide voice recognition service to the wireless communication device in accordance with a preferred embodiment of the present invention.

FIG. 7 is a logic flow diagram of steps executed by a wireless system infrastructure to provide voice recognition service to a wireless communication device in accordance with a preferred embodiment of the present invention.

### DETAILED DESCRIPTION OF A PREFERRED EMBODIMENT

Generally, the present invention encompasses a method and apparatus for providing voice recognition service to a wireless communication device. Voice recognition information (e.g., a context model and voice training parameters) is generated by a wireless communication device user and stored in a memory (e.g., a smart or SIM card) of the wireless communication device to form one portion of a voice recognition processing engine. Another portion of the voice recognition processing engine (e.g., a voice recognition processor and operating software therefor) is implemented in a wireless system infrastructure. The wireless communication device transmits the voice recognition information to the wireless system infrastructure preferably upon request for such information by the wireless system infrastructure. The wireless system infrastructure then uses both portions of the voice recognition processing engine to provide voice recognition service to the wireless communication device and its user during operation of the wireless communication device.

By providing voice recognition functionality to the wireless communication device in this manner, the present invention enables voice recognition to be used by a wireless communication device on any system that has infrastructure-based voice recognition capability, without requiring a new context model to be generated prior to accessing each system as is required in the prior art. Thus, when a wireless communication device roams from its home system to another system that supports voice recognition (e.g., includes an infrastructure-based voice recognition processor), the wireless device need only transmit its previously stored voice recognition information to the infrastructure to enable the infrastructure to provide voice recognition service to the wireless device. In addition, by only storing a small portion of the overall voice recognition processing engine in the wireless device, the present invention eliminates the need for a high power processor in the wireless device to support voice recognition functionality. Further, by dividing the voice recognition processing engine between the wireless device and the wireless system infrastructure, the present invention facilitates the use of a much more expansive user-defined vocabulary (e.g., context model) than does wireless device-based voice recognition systems because the voice recognition system of the present invention is much less processor-limited due to incorporation of the voice recognition processor in the infrastructure rather than the wireless device. Thus, the present invention provides voice recognition functionality that follows a wireless communication device wherever it goes by utilizing a wireless device that maintains its own voice recognition information (e.g., context model) and utilizing a wireless system infrastructure that maintains the high performance processing necessary to facilitate voice recognition service.

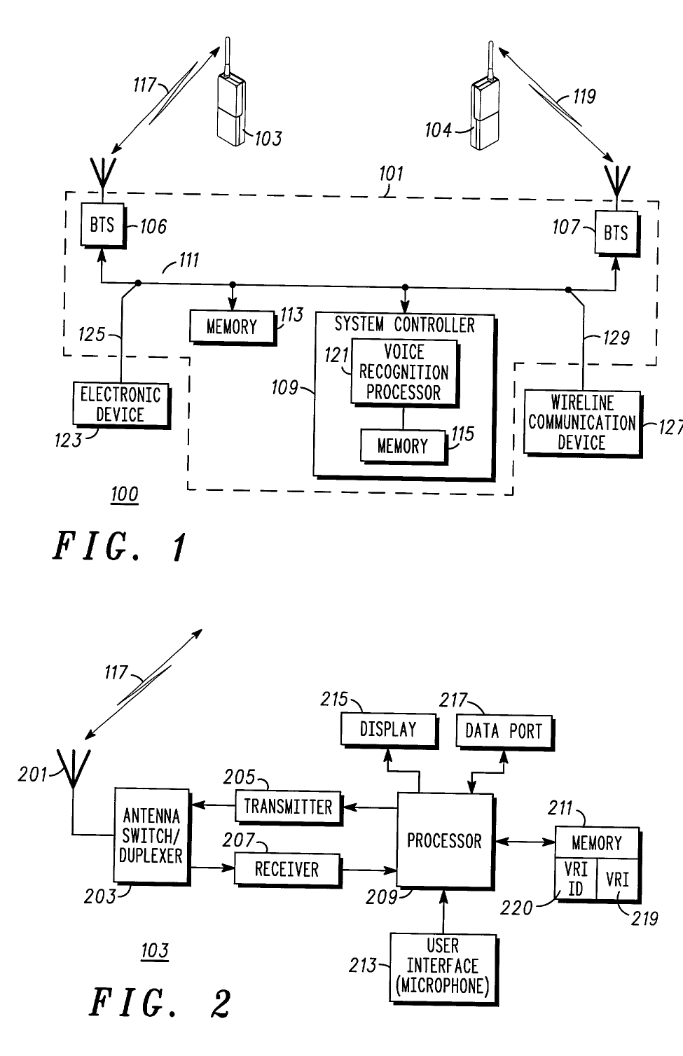

The present invention can be more fully understood with reference to FIGS. 1-7, in which like reference numerals designate like items. FIG. 1 is a block diagram of a wireless communication system 100 in accordance with the present invention. The wireless communication system 100 includes a wireless system infrastructure 101 and one or more wireless communication devices 103, 104 (two shown). The wireless communication system may be any form of wireless system, including without limitation, a cellular communication system, a PCS system, a multi-service system, such as the “MOTOROLA” “iDEN” system, a two-way radio system, a paging system, a wireless data system, or any other wireless system that supports voice recognition as herein described.

The wireless system infrastructure 101 includes one or more base transceiver sites (BTSs) 106, 107 (two shown), a system controller 109, a local or wide area network (LAN/WAN) 111 , and one or more memory devices 113 that may be separately coupled to the LAN/WAN 111 as shown or be distributed in the various infrastructure components (such as memory device 115 in the system controller 109). Each BTS 106, 107 is a conventional BTS that includes one or more base transceiver stations that preferably transmit and receive digital messages over a respective wireless communication link 117, 119 (e.g., radio frequency (RF) channel). The system controller 109 is operably coupled to each BTS 106, 107 via the LAN/WAN 111 and preferably includes a voice recognition processor 121 and optional memory 115. The system controller 109 is preferably a controller that coordinates or controls communication within the entire wireless system 100. For example, the system controller 109 may be a central controller of a two-way trunked radio system, a mobile switching center (MSC) of a cellular, PCS or multi-service system, a dispatch application processor (DAP) of a multi-service system, such as the “iDEN” system, or a base station controller in a single base station system. The voice recognition processor 121 preferably comprises a microprocessor or another other suitable processor that operates in accordance with operational or programming instructions (e.g., a software engine) stored in memory device 115 or some other memory device 113. Alternatively, the voice recognition processor 121 may be another microprocessor, a microcontroller, a digital signal processor (DSP), a state machine, logic circuitry, or any other device or group of devices that processes information based on operational or programming instructions. One of ordinary skill in the art will recognize that when the voice recognition processor 121 has one or more of its functions performed by a state machine or logic circuitry, the memory 115 containing the corresponding operational instructions may be embedded within the state machine or logic circuitry. In the simplest systems, the voice recognition processor 121 may reside in a personal computer and the voice recognition software engine may run in the background on the personal computer, provided that the microprocessor and the memory 115 are appropriately sized.

The memory devices 113, 115 may include one of more of various digital storage media, such as any form of random access memory (RAM), any form of read only memory (ROM), a hard disk, or any other medium for storing digital information. As mentioned above, the memory 115 preferably stores operational instructions that, when executed, cause the voice recognition processor 121 to perform its particular functions. The operations performed by the voice recognition processor 121 and the rest of the elements of the wireless communication system 100 are described in detail below.

An electronic device 123 may be coupled to the wireless system's LAN/WAN 111 via an appropriate communication link 125, such as the Internet (e.g., via a dial-up telephone line, a digital subscriber line (DSL), an integrated digital systems network (ISDN) connection, or a cable connection) or some other wide area Internet protocol (IP) network. Such an electronic device 123 may be an Internet appliance, an IP addressable garage door opener, an IP addressable television or other entertainment device, or any other electronic device that may be operated or controlled remotely in accordance with digital or analog control signals issued by the wireless system infrastructure 101. As described in detail below, such control signals are generated in response to voice commands issued by a user of a wireless communication device 103. One or more wireline communication devices 127 (one shown), such as a telephone, an audio interface to a computer, a data terminal, or a set top box, and/or any other means to send and receive audio commands, may also be coupled to the wireless system's LAN/WAN 111 via an appropriate communication link 129 (e.g., via the public switched telephone network (PSTN), the Internet, or some other network) to facilitate a communication between a user of the wireline device 127 and the user of the wireless device 103 having voice recognition functionality.

A preferred embodiment of a wireless communication device 103 having voice recognition functionality in accordance with the present invention is illustrated in block diagram form in FIG. 2. The wireless device 103 includes, inter alia, an antenna 201, an antenna switch/duplexer 203, a transmitter 205, a receiver 207, a processor 209, memory 211 for storing operating instructions executable by the processor 209 and for storing other information (e.g., voice recognition information and wireless device identification information) as described in more detail below, a user interface 213, a display 215, and a data port 217.

The wireless device 103 may be any two-way communication device capable of communicating in a wireless communication system 100. Thus, the wireless device 103 may be a two-way radio, a radiotelephone, a two-way pager, a wireless data terminal, a laptop computer, a palmtop computer, a personal digital assistant (PDA), or any other two-way device having wireless capabilities.

The antenna 201 may include a single antenna element or multiple antenna elements (e.g., an array). The antenna switch/duplexer 203 may be a known PIN diode or other switch to implement an antenna switch for half-duplex operation or a known arrangement of filters to implement a duplexer for full duplex operation.

The transmitter 205 and the receiver 207 include appropriate circuitry to enable digital or analog transmissions over a wireless communication link 117. For example, the transmitter 205 and the receiver 207 may be implemented as an appropriate wireless modem, or as conventional transmitting and receiving components in a two-way wireless device. In the event that the transmitter 205 and the receiver 207 are implemented as a wireless modem, the wireless modem may be located on a Personal Computer Memory Card International Association (PCMCIA) card that may be inserted into a computing device, such as a laptop or palmtop computer or PDA, to facilitate wireless communications. Wireless modems are well known; thus no further discussion of them will be presented except to facilitate an understanding of the present invention.

The processor 209 may be a microprocessor, a microcontroller, a digital signal processor (DSP), a state machine, logic circuitry, or any other device or group of devices that processes information based on operational or programming instructions. One of ordinary skill in the art will recognize that when the processor 209 has one or more of its functions performed by a state machine or logic circuitry, the memory containing the corresponding operational instructions may be embedded within the state machine or logic circuitry. The memory 211 may include one of more of various digital storage media, such as RAM, ROM, flash memory, a smart card, a subscriber identity module (SIM) card, a floppy disk, a compact disk read only memory (CD-ROM), a hard disk drive, a digital versatile disk (DVD), flash memory or any other medium or device(s) for storing digital information. Thus, the memory 211 may be embedded within the wireless device 103, may be inserted into or otherwise operably coupled to the wireless device 103 by the wireless device user, or both (e.g., certain information may be stored in embedded ROM, while other information may be stored on an insertable SIM card). As mentioned above, the memory 211 preferably stores operating instructions that, when executed, cause the processor 209 to perform its particular functions. In addition, the memory 211 preferably includes one or more memory locations 219, 220 (e.g., registers or sets of registers) that store a small portion of a voice recognition processing engine, as described in detail below, to enable the wireless device to receive voice recognition service in multiple wireless systems. The operations performed by the processor 209 and the rest of the elements of the wireless communication device 103 are described in detail below.

The user interface 213 preferably includes a microphone to receive voice instructions issued by the wireless device user and may also include other conventional user interface elements, such as a keyboard, a keypad, a mouse or rollerball, a thumbwheel, a touchscreen, a touchpad, or any other device for allowing the user of the wireless device 103 to make a selection or instruct the device 103 to take some action. The display 215 may be any conventional cathode ray tube (CRT) display, liquid crystal display (LCD), or other display. In addition, when audio display is desired, the display 215 preferably includes an audio display device, such as one or more speakers. Although not shown in FIG. 2, the wireless device 103 may further include an alerting device, such as a tone generator that produces an audible alert or an electrically actuatable vibration device, to alert the device that a message or a communication has been received that may require the user's attention. The data port 217 preferably comprises a conventional data port, such as a wired or wireless serial port or equivalent.

FIG. 3 is a block diagram of an arrangement for generating voice recognition information and storing the voice recognition information in the wireless communication device memory 211 in accordance with a preferred embodiment of the present invention. As illustrated, the arrangement includes a voice recognition information (VRI) generation node 301 and a communication link 303 coupling the VRI generation node 301 to the wireless device memory 211 on or in which the voice recognition information is to be stored. When the voice recognition information is to be stored in embedded memory 211 of the wireless device 103, the communication link 303 is coupled to the data port 215 of the wireless device 103. On the other hand, when the voice recognition information is to be stored in or on a memory device 211 that is insertable into or otherwise operably coupleable to the wireless device 103, the communication link 303 is coupled to an appropriate drive 304 for writing data to the particular memory device 211. The VRI generation node 301 is preferably coupled by an appropriate communication link 305 (e.g., the Internet) to the LAN/WAN (e.g., LAN/WAN 111) of the wireless device's home wireless system infrastructure 101 to allow the VRI generation node 301 to communicate with the voice recognition processor 121 as described in more detail below.

The VRI generation node 301 preferably comprises a computer (e.g., a personal computer, a workstation, a laptop or notebook computer, or a local server) or similar data device executing a software program that provides a user-friendly graphical user interface (GUI) to enable the wireless device user to generate unique voice recognition information to be used in providing voice recognition functionality to the wireless device 103. In a preferred embodiment, the voice recognition information includes a context model and voice training parameters. The context model is a user-defined, unique, personal vocabulary that includes a set of instructions and operands that are to be automatically recognized by the infrastructure's voice recognition processor 121 upon receipt of an instruction and operand(s) from the wireless device 103. The context model may include instructions that, inter alia, allow the user of the wireless device to control operation of the wireless device 103 (e.g., turn the device 103 off, or turn features of the device 103 on and off), control operation of a remotely located electronic device 123 (e.g., control operation of the wireless device user's residential garage door opener, sprinkler system, security system, or other IP-addressed device), retrieve information stored in the wireless device 103 (e.g., retrieve stored telephone numbers or other contact information), establish a communication in a wireless communication system (e.g., initiate a telephone call with one or more wireless and/or wireline communication devices 104, 127), and control, to some extent, operation of the infrastructure's voice recognition processor 121 (e.g., activate or wake-up the voice recognition processor 121).

An exemplary context model may include the following instruction set and operands:

<Action>::= SEND MESSAGE <conj> <Person>

| DIAL <PhoneNumber>
| CALL <Person> <conj> <Path>
| PLAY MESSAGE <conj> <Person>
| OPEN <conj> <Doors> DOOR
| CLOSE <conj> <Doors> DOOR
| DISPLAY MESSAGES
| CANCEL
| TURN ON <Devices>
| TURN OFF <Devices>
| STANDBY MODE

<conj>::= ON

| TO
| FROM
| ON THE
| THE

<PhoneNumber>::= <Singles> <Singles> <Singles> <Singles> <Singles>

| <Singles> <Singles> <Singles> <Singles> <Singles> <Singles>

<Singles>::= OH

| ZERO
| ONE
| TWO
| THREE
| FOUR
| FIVE
| SIX
| SEVEN
| EIGHT
| NINE
| HUNDRED

<Person>::= MOM

| DAD
| PIZZA
| BABY SITTER
| [Other Names, Nicknames or Places]

<Path>::= RADIO

| CELL PHONE
| PHONE

<Doors>::= FRONT

| GARAGE
| LEFT GARAGE
| RIGHT GARAGE

<Devices>::= SECURITY SYSTEM

| OVEN
| SPRINKLER SYSTEM

One of ordinary skill in the art will recognize and appreciate that various other context models may be readily generated to coincide with the particular requirements of the wireless device user.

In addition to a context model, the voice recognition information preferably includes training parameters related to a voice of the wireless device user. The voice training parameters include data for adapting the infrastructure's voice recognition processor to the voice characteristics of the wireless device user. For example, training parameters may include the following phonemes representing English sounds in accordance with IBM's Voice Type Application Factory for Windows or any other user-defined phonemes:

| | | | | | |
|---|---|---|---|---|---|
| AA | c/o/t | AE | b/a/t | AH | b/u/t |
| AO | b/ough/t | AX | th/e/ | AXR | summ/er/ |
| AY | b/i/te | B | /b/ob | BD | tu/b/e |
| CH | /ch/urch | D | /d/ad | DD | delete/d/ |
| DH | /th/ey | EH | b/e/t | ER | b/ir/d |
| EY | b/ai/t | F | /f/ire | G | /g/ag |
| GD | ta/g/ | HH | /h/ay | IH | b/i/t |
| IX | ros/es/ | IY | b/ea/t | JH | /j/udge |
| K | /k/ick | KD | comi/c/ | L | /l/ed |
| M | /m/om | N | /n/on | NG | si/ng/ |
| OW | b/oa/t | OY | b/oy/ | P | /p/op |
| PD | shi/p/ | R | /r/ed | S | /s/is |
| SH | /sh/oe | SIL | (silence) | T | /t/o |
| TD | se/t/ | TH | /th/ief | TS | i/ts/ |
| UH | b/oo/k | UW | b/oo/t | V | /v/ery |
| W | /w/et | Y | /y/et | Z | /z/oo |
| ZH | mea/s/ure | | | | |

Training parameters may additionally include modifications or corrections to such phonemes to account for (a) dialect, inflection, or other characteristics of the wireless device user's voice, (b) processing (e.g., speech encoding) performed by the wireless device 103 to facilitate transmission over the wireless link 117, and/or (c) audio-modifying characteristics of the wireless link 117 itself. For example, the training parameters may include the frequency ranges associated with various individuals in accordance with the well-known Markov speech models to enable the voice recognition processor to optimize performance based on the gender, age, or particular speech patterns of the wireless device user. Alternatively or additionally, the training parameters may include correction factors to account for the audio characteristics of the wireless link 117 or speech encoding performed by the wireless device 103 to obtain a desired transmission quality. For example, correction factors may be used to modify the Markov speech models to match the speech models to the characteristics of the sound signature (e.g., phonemes) of the wireless device user as such sound signature is actually processed by the wireless device 103 and received over the wireless link 117.

In a preferred embodiment, the wireless device user uses the VRI generation node 301 and the wireless device 103 to generate his or her unique voice recognition information and store the generated voice recognition information in one or more memory locations of the wireless device memory 211. The software executed by the VRI generation node 301 preferably walks the wireless device user through the steps required to generate the voice recognition information and store it in the wireless device 103. For example, the software may first instruct the user to enter a command or instruction (e.g., “DIAL”) using the keyboard and then instruct the user to say the command a predetermined number of times (e.g., two or three times), with appropriate waiting periods between repetitions, into a microphone (not shown) of the wireless device 117. The wireless device 117 then transmits the audio command to the voice recognition processor 121 via a BTS 106 and the infrastructure's LAN/WAN 111. Responsive to receiving the audio command, the voice recognition processor 121 generates the training parameters together with any corrections necessary to account for the wireless link 117 and/or the wireless device's audio processing, and provides the training parameters to the VRI generation node 301 via the infrastructure's LAN/WAN 111 and communication link 305.

Alternatively, instead of repeatedly speaking the command into the wireless device's microphone to enable the voice recognition processor 121 to generate the training parameters for the command, the wireless device user might be instructed to say the command into a microphone (not shown) forming part of the VRI generation node 301 so that the software within the VRI generation node 301 may generate the training parameters for the command. In this case, the VRI generation node 301 may include a digital signal processor programmed to simulate the audio anomalies introduced by the wireless link 117 and/or the speech processing components of the wireless device 103 to enable the VRI generation node 301 to attempt to take into account such anomalies when generating the training parameters for the command. Once voice recognition information has been generated for one command, the VRI generation node software continues the voice recognition information generation process by instructing the user in the manner described above until the user's unique context model and associated training parameters have been completely generated.

After the voice recognition information has been generated (either by the VRI generation node 301 and the voice recognition processor 121 or solely by the VRI generation node 301), or, alternatively, during generation of the voice recognition information, the VRI generation node 301 either automatically downloads the voice recognition information into an appropriate memory location or locations 219 of the wireless device memory 211 via communication link 303 (either into the wireless device 103 itself or into the portable wireless device memory currently residing in the memory drive 304) or downloads the voice recognition information only after receiving authorization to do so from the wireless device user. Prior to generating voice recognition information through transmissions over the wireless link 117 and/or storing voice recognition information in embedded wireless device memory 112, the wireless device user preferably places the wireless device 103 in an appropriate mode (e.g., a programming mode) to receive and participate in the generation of the voice recognition information. In addition, when the wireless link 117 and the voice recognition processor 121 are utilized to generate the voice recognition information (e.g., training parameters), the wireless device user preferably transmits a request to begin generating voice recognition information to the system controller 109 to allow the system controller 109 to allocate the voice recognition processor 121 or a portion thereof for the purpose of generating voice recognition information.

The communication link 303 coupling the VRI generation node 301 to the wireless communication device 103 and/or the memory drive 304 is preferably a wireline link, such as a Universal Serial Bus (USB) link. Alternatively, the communication link 303 may be a wireless link operating in accordance with the Bluetooth wireless communication standard, another wireless link (including, but not limited to, an infrared link, a radio frequency link, or a microwave link), another wireline link (including, but not limited to, an asymmetric or symmetric DSL link, an ISDN link, a frame relay link, an asynchronous transfer mode (ATM) link, a low speed telephone line, or a hybrid fiber coaxial network), or an optical link (e.g., an infrared link as defined by the well-known Infrared Data Association (irDA) standard). The VRI generation node 301 may also include a receptacle (not shown) in which the wireless device 103 may be placed such that a wireline or optical data port of the wireless device 103 may be appropriately coupled to the communication link 303. Additionally, the VRI generation node 301 may further include a memory drive in which the portable memory device 112 (e.g., smart card or disk) may be placed to eliminate the need for a separate memory drive 304.

An identifier (e.g., a date stamp or a version number) associated with the voice recognition information is also preferably stored in an appropriate memory location 220 of the wireless device memory 211 during storage of the voice recognition information. The identifier is used by the wireless system infrastructure 101, as described in detail below, to determine whether previously stored voice recognition information needs to be updated.

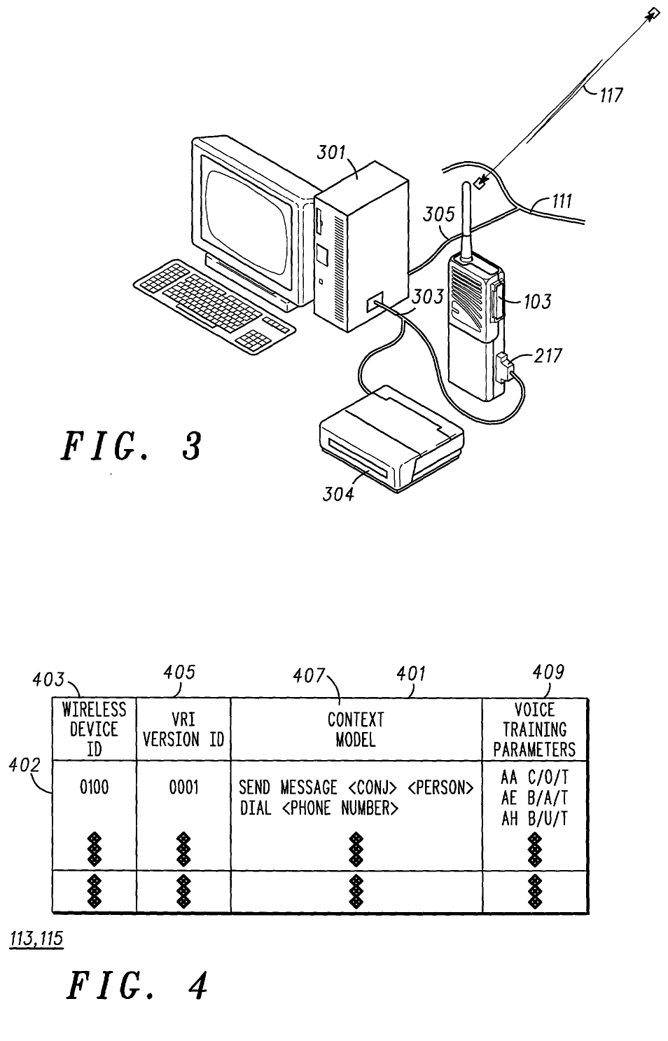

FIG. 4 illustrates an exemplary voice recognition information database 401 stored in a memory 113, 115 of the wireless system infrastructure 101 in accordance with a preferred embodiment of the present invention. Each entry 402 of the database 401 preferably includes a wireless device identifier 403, a voice recognition information (VRI) identifier 405 and voice recognition information (e.g., context model 407 and voice training parameters 409). Accordingly, each entry 402 corresponds to a unique wireless communication device 103. The information contained in each entry 402 is received from the particular wireless device 103 as described in detail below.

Referring to FIGS. 1-4, operation of the wireless communication system 100 in accordance with the present invention occurs substantially as follows. As described above with respect to FIG. 3, the wireless device user preferably uses a VRI generation node 301, the wireless device 103 and the infrastructure's voice recognition processor 121 to generate voice recognition information and store the voice recognition information in a memory device 211 of the wireless device 103. The voice recognition information preferably includes a user-defined context model and user-specific voice training parameters, but may include additional information as may be desired to optimize recognition of the user's voice. If the VRI generation node 301 is coupled to the LAN/WAN 111 of the wireless device's home system infrastructure 101, the VRI generation node 301 may download the generated voice recognition information to a memory device (e.g., memory device 113) of the home system infrastructure for storage as a voice recognition information database entry 402.

Some time after the voice recognition information has been stored in the wireless device memory 211, the user attempts to operate the wireless device 103 in the wireless communication system 100 (e.g., turns on the wireless device 103 while being located within the coverage area of the wireless system 100). Such an attempt is detected in cellular systems and various other systems as an attempt to register in the wireless system 100. To register or request to operate in the wireless system 100, the wireless device 103 transmits a registration request, or some other similar request to operate, to a BTS 106 of the wireless system infrastructure 101. The request preferably includes an identifier associated with the wireless device 103 (e.g., a serial number or some other form of subscriber identification) and an indication that the wireless device 103 is authorized to use the system's voice recognition service. The request preferably further includes an identifier (e.g., a date stamp or version number) associated with the voice recognition information stored in the memory 211 of the wireless device 103. As noted above with respect to FIG. 3, the VRI identifier was preferably stored in the device memory 211 during the time period that the voice recognition information was stored in the device memory 211.

The BTS 106 forwards the received registration request to the system controller 109 via the LAN/WAN 111 in accordance with known techniques. Preferably as part of the registration procedure, the system controller 109 extracts the wireless device identifier (e.g., 0100) and compares it to the wireless device identifiers for which voice recognition information is already stored in the infrastructure memory 113. In the event that the system controller 109 determines that no voice recognition information is presently stored for the wireless device 103, the system controller 109 sends a request for the wireless device's voice recognition information to the wireless device 103 via the LAN/WAN 111, the BTS 106, and the wireless link 117 in accordance with known control signaling techniques.

On the other hand, in the event that the system controller 109 determines that voice recognition information is presently stored for the wireless device 103 (i.e., an entry 402 exists for the wireless device 103 in the VRI database 401 stored in infrastructure memory 113), the system controller 109 extracts the VRI identifier and compares it to the VRI identifier contained in the VRI database entry 402 for the wireless device 103. When the VRI identifier received from the wireless device 103 matches the VRI identifier contained in the VRI database entry 402 for the wireless device 103, the system controller 109 determines that the voice recognition information stored in infrastructure memory 113 is current and proceeds with completing the wireless device's registration. By contrast, when the VRI identifier received from the wireless device 103 differs from the VRI identifier contained in the VRI database entry 402 for the wireless device 103, thereby indicating a change or update in wireless device voice recognition information, the system controller 109 sends a request for the wireless device's voice recognition information to the wireless device 103 via the LAN/WAN 111, the BTS 106, and a wireless link 117 in accordance with known control signaling techniques. Therefore, in accordance with the present invention, voice recognition information for a particular wireless device 103 is preferably only communicated to the wireless system infrastructure 101 to either update existing voice recognition information for the particular wireless device 103 or establish an original VRI database entry 402 for the particular wireless device 103, thereby minimizing control traffic associated with providing voice recognition service to the wireless device 103.

Some time after a request for voice recognition information is transmitted from the wireless system infrastructure 101, the wireless device receiver 207 receives, de-modulates and, optionally, decodes the request in accordance with known techniques to generate a baseband representation of the request. The wireless device receiver 207 provides the baseband representation of the request to the wireless device processor 209. Responsive to the request, the wireless device processor 209 retrieves the requested voice recognition information from the wireless device memory 211, prepares a data message containing the retrieved voice recognition information and optionally the VRI identifier, and provides the data message to the wireless device transmitter 205 with instruction to transmit the data message to the wireless system infrastructure 101. Upon receiving the data message and instruction from the wireless device processor 209, the wireless device transmitter 205 transmits the data message containing the voice recognition information to the wireless system infrastructure 101 via the antenna switch/duplexer 203, the antenna 201 and a wireless link 117 in accordance with known control signaling techniques.

The wireless device's voice recognition information is subsequently received by the system controller 209 via the BTS 106 and the LAN/WAN 111. The system controller 209 then stores the received voice recognition information in infrastructure memory 113 in either a new VRI database entry 402 (when no prior entry existed) or the wireless device's current database entry 402 (e.g., overwrites the current database entry 402) for future use in providing voice recognition service to the wireless device 103. As illustrated in FIG. 4, each database entry 402 stored in infrastructure memory 113 includes the particular wireless device's identifier 403, the particular wireless device's VRI identifier 405, and the particular wireless device's voice recognition information (e.g., context model 407 and voice training parameters 409).

In accordance with the present invention, the wireless device's voice recognition information may be originally stored in system infrastructure memory 113 of the wireless device's home system (e.g., the cellular or other system that the wireless device 103 is provisioned in) in one of two ways. First, the voice recognition information may be downloaded to the infrastructure memory 113 during substantially the same time period that the voice recognition information is generated and stored in the wireless device 103 as described above with respect to FIG. 3. Alternatively, the voice recognition information may be transmitted to the wireless system infrastructure 101 and subsequently stored in infrastructure memory 113 responsive to the wireless device's receipt of a request for voice recognition information during device registration or setup. In other non-home wireless systems, the wireless device's voice recognition information is preferably originally stored in infrastructure memory 113 responsive to receipt of the voice recognition information during device registration or setup. Modifications or updates to the wireless device's voice recognition information are preferably stored in infrastructure memory 113 responsive to receipt of the voice recognition information during registration or setup of the particular wireless device 103.

Some time after the wireless device 103 has been set up to operate in the wireless communication system 100 (e.g., has been registered in the wireless system 100), the user interface microphone 213 of the wireless device 103 receives a voice message instruction from the wireless device user. The voice message instruction is provided in accordance with known techniques to the wireless device processor 209. The wireless device processor 209 generates a data message based on the instruction and instructs the wireless device transmitter 205 to transmit the data message to the wireless system infrastructure 101. The BTS 106 receives the data message containing the voice message instruction, processes it in accordance with known techniques, and provides it to the system controller 109 via the LAN/WAN 111. The system controller 109 extracts the voice message instruction from the data message and compares it to the context model instructions forming part of the particular wireless device's voice recognition information to determine whether the received data message is a voice message instruction. When the received data message matches one of the context model instructions, the system controller 109 employs the voice recognition processor 121 to generate a data message representative of the received instruction based on the stored voice recognition information (e.g., to take into account voice training parameters in determining the operands of the instruction). The data message is then provided to the appropriate entity to facilitate execution of the received instruction. For example, if the instruction is an instruction to place a phone call to the baby sitter, the voice recognition processor 121 sends the data message to the call set up portion of the system controller 109 or to another controller in the system responsible for setting up radiotelephone calls. Alternatively, if the instruction is an instruction directed at the wireless device 103 to retrieve contact information stored in the wireless device 103, the voice recognition processor 121 sends the data message to the wireless device via the LAN/WAN 111, the BTS 106 and the wireless link 117 so that the wireless device processor 209 may execute the instruction.

As described above, the present invention provides a technique in which voice recognition service may be provided to a wireless communication device in any system in which the wireless device may operate and that includes an infrastructure-based voice recognition processor. In accordance with the present invention, one portion of a voice recognition processing engine (e.g., the context model and voice training parameters) is stored in the wireless device, while the remainder of the voice recognition processing engine (e.g., the voice recognition processor and its associated operating software) is implemented in the wireless system infrastructure. When the portion of the engine that is stored in the wireless device is needed by the wireless system infrastructure to provide voice recognition service to the wireless device, the wireless system infrastructure requests the portion from the wireless device, thereby allowing wireless systems with voice recognition capability to provide voice recognition service to wireless devices without requiring the wireless devices to generate new voice recognition information each time the devices desire to operate in a new system. In contrast to prior art voice recognition systems that are either completely infrastructure-based or completely wireless device-based, the present invention bifurcates the voice recognition processing engine to obtain both the flexibility benefits associated with a completely device-based voice recognition system and the context model capacity benefits associated with a completely infrastructure-based voice recognition system. The bifurcation of the processing engine is preferably such that only a small portion of the engine (i.e., the data file making up the voice recognition information) is stored in the wireless device, thereby minimizing any added wireless device costs associated with maintaining a portion of a voice recognition processing engine in a wireless device.

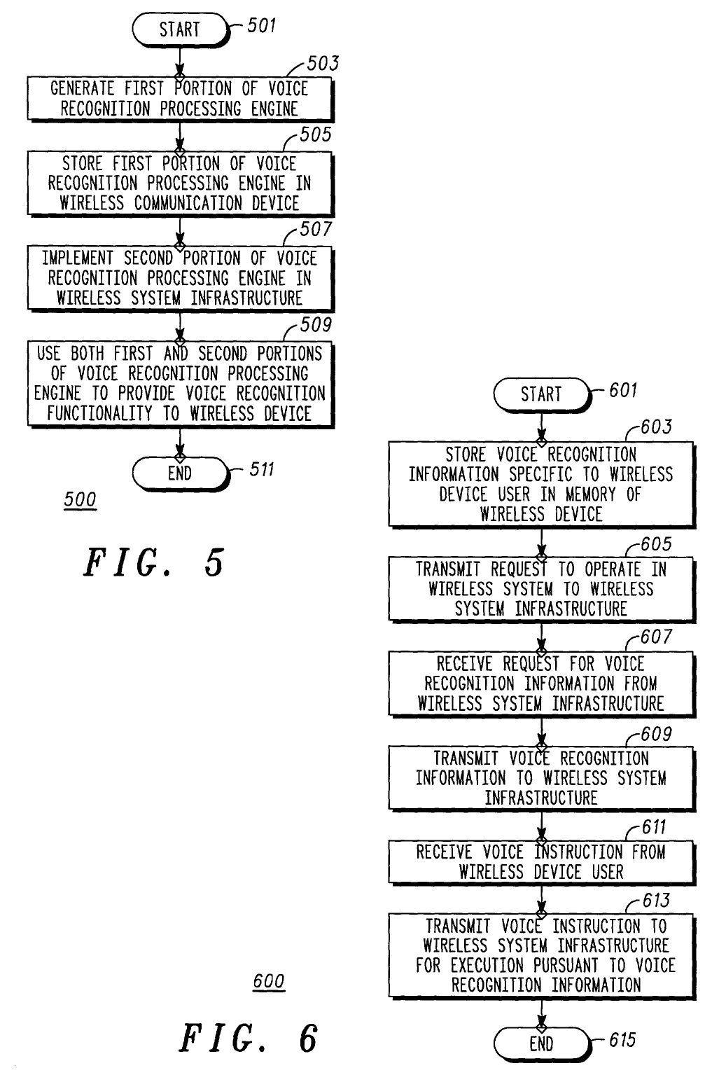

FIG. 5 is a logic flow diagram 500 of steps executed to provide voice recognition functionality to a wireless communication device in accordance with one embodiment of the present invention. The logic flow begins (501) when a first portion of a voice recognition processing engine is generated (503) and stored (505) in a memory of (i.e., that is usable by) the wireless communication device. The first portion preferably consists of voice recognition information and is interactively generated by the wireless device user using a VRI generation node, such as a computer. The voice recognition information preferably includes a user-defined context model and training parameters related to the voice characteristics of the wireless device user. Storage of the voice recognition information in a portable memory, such as memory embedded in the wireless device or a memory card that may be inserted or otherwise coupled to the wireless device, allows the wireless device user to carry the voice recognition information with him or her wherever the user goes for use in various communication systems.

A second portion of the voice recognition processing engine is implemented (507) in the wireless system infrastructure of the wireless system in which the wireless device intends to operate. The second portion of the voice recognition processing engine is much larger than the first portion stored in the wireless device. The second portion of the voice recognition processing engine preferably includes a voice recognition processor and operational or programming instructions for operating the voice recognition processor. Thus, the complex and costly component of the voice recognition processing engine is implemented within the wireless system infrastructure to facilitate extensive voice recognition functionality without significantly increasing the cost of the wireless device.

Both the first portion and the second portion of the voice recognition processing engine are then combined and used (509) to provide voice recognition functionality to the wireless device, and the logic flow ends (511). In a preferred embodiment, the wireless device transmits the first portion of the voice recognition processing engine (e.g., in response to a request for voice recognition information received from the infrastructure) to the wireless system infrastructure for storage in a memory of the infrastructure. The system infrastructure then uses both portions of the voice recognition processing engine to identify and execute (or generate data messages to facilitate execution of) voice message instructions issued by the user of the wireless device. Bifurcation of the voice processing engine in this manner enables the wireless device user to obtain the benefits of both completely infrastructure-based and completely device-based voice recognition systems, without encountering the attendant disadvantages of such systems.

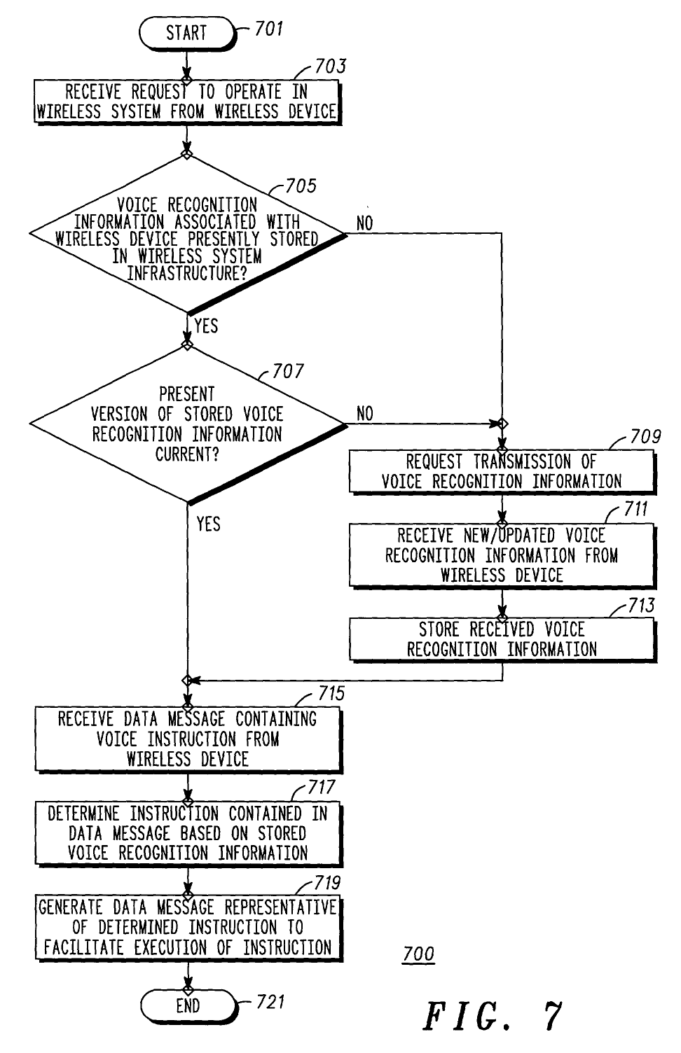

FIG. 6 is a logic flow diagram 600 of steps executed by a wireless communication device to enable a wireless system infrastructure to provide voice recognition service to the wireless communication device in accordance with a preferred embodiment of the present invention. The logic flow begins (601) when the wireless device stores (603) voice recognition information specific to the wireless device's user in a memory of (e.g., either embedded in or operably coupleable to) the wireless device. The voice recognition information preferably includes a context model and voice training parameters as described in detail above with respect to FIGS. 1-4. The voice recognition information is useable by a voice recognition processor of the wireless system infrastructure to provide voice recognition service to the wireless communication device.

Some time after the voice recognition information has been stored in a memory of the wireless device, the wireless device transmits (605) a request to operate in the wireless communication system to the wireless system's infrastructure. The request to operate preferably comprises a registration request or other similar request and includes a wireless device identifier (e.g., an international mobile subscriber identification (IMSI) or a device serial number) and a VRI identifier (e.g., a date stamp or a version number). If either identifier does not match a corresponding identifier stored in a memory of the wireless system infrastructure, thereby indicating that the infrastructure either does not have any stored voice recognition information associated with the wireless device or has voice recognition information stored, but such information has been changed and therefore is out-of-date, the wireless device receives (607) a request for voice recognition information from the wireless system infrastructure. Responsive to the request for voice recognition information, the wireless device transmits (609) its stored voice recognition information to the wireless system infrastructure to facilitate subsequent use of the voice recognition information by the infrastructure's voice recognition processor during operation of the wireless device.

At a later time, the wireless device receives (611) a voice instruction from the wireless device user via the device's microphone, thereby signifying the user's intent to use the voice recognition functionality of the wireless system. The wireless device generates a data message based on the received instruction and transmits (613) the data message containing the voice instruction to the wireless system infrastructure for execution of the instruction pursuant to the stored voice recognition information, and the logic flow ends (615). If the instruction is to be executed by the wireless device, the wireless device would subsequently receive a data message from the wireless system infrastructure instructing the device to execute the instruction.

FIG. 7 is a logic flow diagram 700 of steps executed by a wireless system infrastructure to provide voice recognition service to a wireless communication device in accordance with a preferred embodiment of the present invention. The logic flow begins (701) when the infrastructure receives (703) a request to operate in the wireless system (e.g., a registration and a voice recognition mode service request) from the wireless device. As noted above, the request to operate preferably includes an identifier associated with the wireless device and an identifier associated with voice recognition information stored in a memory of the wireless device. Upon receiving the request to operate, the wireless system infrastructure determines (705) whether there is any voice recognition information associated with the wireless device presently stored in infrastructure memory. This determination is preferably made by comparing the wireless device identifier to wireless device identifiers stored in a VRI database portion of infrastructure memory. If the wireless device identifier matches a wireless device identifier stored in the VRI database, then voice recognition information associated with the wireless device is presently stored in infrastructure memory; otherwise, it is not.

When voice recognition information associated with the wireless device is presently stored in infrastructure memory, the infrastructure determines (707) whether the presently stored version of the voice recognition information is current (i.e., the most up-to-date version). This determination is preferably made by comparing the received VRI identifier with the VRI identifier associated with the voice recognition information presently stored in the VRI database entry for the wireless device. If the newly received VRI identifier matches the presently stored VRI identifier, then the present version of the stored voice recognition information is current; otherwise (i.e., when the VRI identifiers differ), it is not.

When either voice recognition information associated with the wireless device is not presently stored in infrastructure memory or voice recognition information associated with the wireless device is presently stored, but is not current, the wireless system infrastructure requests (709) transmission of the wireless device's voice recognition information preferably by transmitting an appropriate request for such information to the wireless device. Some time after transmitting the request, the infrastructure receives (711) new or updated (depending on which scenario prompted transmission of the request in step 709) voice recognition information from the wireless device and stores (713) the received voice recognition information in a memory device of the infrastructure. As described above, the voice recognition information preferably includes a context model containing a set of user-defined instructions to be executed by one or more of the wireless device, the wireless system infrastructure (e.g., the wireless system controller and/or the infrastructure's voice recognition processor), and communication devices or other electronic devices coupled to the wireless system infrastructure via appropriate communication links. The voice recognition information also preferably includes a set of training parameters (e.g., phonemes and Markov speech models) that may be used as necessary to adapt the infrastructure's voice recognition processor to the voice characteristics of the wireless device's user. Having received the original or updated voice recognition information from the wireless device, the wireless system infrastructure is ready to provide voice recognition service to the wireless device.

One of ordinary skill in the art will appreciate that voice recognition information need be provided to the system infrastructure only in the event that either no voice recognition information associated with the wireless device is presently stored in the infrastructure or the presently stored voice recognition information is out-of-date. By requesting voice recognition information only when necessary, the protocol of the present invention attempts to minimize control channel traffic associated with providing voice recognition service to the wireless device.

Some time after receiving (711) voice recognition information from the wireless device or determining (705, 707) that voice recognition information need not be received, the wireless system infrastructure receives (715) a data message containing a voice instruction and optionally one or more operands of the instruction from the wireless device. If no operand is received, the instruction may be presumed to be intended for the wireless device itself.

Responsive to the data message, the infrastructure determines (717) the content of the received instruction by comparing the received instruction and operands (if any) to the context model instructions and operands stored in the VRI database entry associated with the wireless device. Once appropriate matches are detected, the infrastructure determines which instruction was sent and the identities of the device or devices to execute the instruction. The infrastructure (preferably via its voice recognition processor) then generates (719) a data message representative of the determined instruction to facilitate execution of the instruction, and the logic flow ends (721). The data message generated by the infrastructure is preferably communicated to the device or devices identified as operand(s) of the instruction in an IP data packet complying with well-known data communication protocols, such as the X10 protocol. Alternatively, the data message may be communicated to the appropriate target device or devices using any data messaging protocol.

The present invention encompasses a method and apparatus for providing voice recognition service to a wireless communication device. With this invention, wireless device users can enjoy the benefits of both completely infrastructure-based and completely subscriber-based voice recognition, without suffering from their accompanying disadvantages. For example, wireless device users can create and use relatively large context models that they would not be able to use in a completely subscriber-based voice recognition system. In addition, wireless devices can maintain voice recognition functionality as they travel or roam from system to system, a benefit not possible with a completely infrastructure-based voice recognition system. The benefits of the present invention are derived primarily from the present invention's separation of the voice recognition processing engine into a small wireless device-based component and a large infrastructure-based component. The wireless device-based component includes a relatively small and inexpensive data file of voice recognition information; whereas, the infrastructure-based component includes the complex and costly voice recognition processor and operating software. Through this unique division of the voice recognition processing engine, the present invention provides a means by which a wireless device can maintain voice recognition functionality across wireless systems without sacrificing context model capabilities.

In the foregoing specification, the present invention has been described with reference to specific embodiments. However, one of ordinary skill in the art will appreciate that various modifications and changes may be made without departing from the spirit and scope of the present invention as set forth in the appended claims. Accordingly, the specification and drawings are to be regarded in an illustrative rather than a restrictive sense, and all such modifications are intended to be included within the scope of the present invention.

Benefits, other advantages, and solutions to problems have been described above with regard to specific embodiments of the present invention. However, the benefits, advantages, solutions to problems, and any element(s) that may cause or result in such benefits, advantages, or solutions, or cause such benefits, advantages, or solutions to become more pronounced are not to be construed as a critical, required, or essential feature or element of any or all the claims. As used herein and in the appended claims, the term “comprises,” “comprising,” or any other variation thereof is intended to refer to a non-exclusive inclusion, such that a process, method, article of manufacture, or apparatus that comprises a list of elements does not include only those elements in the list, but may include other elements not expressly listed or inherent to such process, method, article of manufacture, or apparatus.

What is claimed is:

1. A method for a wireless communication device to enable a wireless system infrastructure to provide voice recognition service to the wireless communication device, the method comprising the steps of:
storing voice recognition information specific to a user of the wireless communication device in a memory of the wireless communication device, the voice recognition information being usable by a voice recognition processor of the wireless system infrastructure to provide voice recognition service to the wireless communication device; and
transmitting the voice recognition information to the wireless system infrastructure for use by the voice recognition processor during operation of the wireless communication device.

2. The method of claim 1, wherein the step of transmitting the voice recognition information is performed responsive to a request for the voice recognition information received from the wireless system infrastructure.

3. The method of claim 1, wherein the voice recognition information comprises a context model.

4. The method of claim 3, wherein the context model includes instructions that allow the user of the wireless communication device to perform at least one of the following functions:
a) control operation of the wireless communication device;
b) control operation of a remotely located electronic device;
c) retrieve information stored in the wireless communication device; and
d) establish a communication in a wireless communication system.

5. The method of claim 3, wherein the voice recognition information further comprises training parameters related to a voice of the user.

6. The method of claim 5, wherein the training parameters comprise data for adapting the voice recognition processor to voice characteristics of the user.

7. A method for a wireless communication device to enable a wireless system infrastructure to provide voice recognition service to the wireless communication device, the wireless system infrastructure forming part of a wireless communication system, the method comprising the steps of:
storing voice recognition information specific to a user of the wireless communication device in a memory of the wireless communication device, the voice recognition information being usable by a voice recognition processor of the wireless system infrastructure to provide voice recognition service to the wireless communication device;
transmitting a request to operate in the wireless communication system to the wireless system infrastructure, the request to operate including a first identifier associated with the wireless communication device and a second identifier associated with the voice recognition information;
receiving a request for voice recognition information from the wireless system infrastructure responsive to the request to operate; and
transmitting the voice recognition information to the wireless system infrastructure responsive to the request for voice recognition information to facilitate use of the voice recognition information by the voice recognition processor during operation of the wireless communication device.

8. The method of claim 7, wherein the request for voice recognition information is received in the event that the second identifier indicates that the voice recognition information has been changed relative to voice recognition information previously received with respect to the wireless communication device.

9. The method of claim 7, wherein the request for voice recognition information is received in the event that the first identifier indicates that no voice recognition information has been previously received with respect to the wireless communication device.

10. A method for providing voice recognition functionality to a wireless communication device, the method comprising the steps of:
storing a first portion of a voice recognition processing engine in the wireless communication device;
implementing a second portion of the voice recognition processing engine in a wireless system infrastructure accessible by the wireless communication device, wherein the first portion is substantially smaller than the second portion; and
using both the first portion and the second portion of the voice recognition processing engine to provide voice recognition functionality to the wireless communication device.

11. The method of claim 10, wherein the first portion of the voice recognition processing engine comprises a context model and voice training parameters.

12. The method of claim 11, wherein the second portion of the voice recognition processing engine comprises a voice recognition processor and programming instructions for operating the voice recognition processor to enable the voice recognition processor to provide voice recognition functionality upon receipt of the first portion of the voice recognition processing engine from the wireless communication device.

13. A method for a wireless system infrastructure to provide voice recognition service to a wireless communication device, the wireless system infrastructure forming part of a wireless communication system, the method comprising the steps of:
receiving a request to operate in the wireless communication system from the wireless communication device, the request to operate including a first identifier associated with the wireless communication device and a second identifier associated with voice recognition information stored in a memory of the wireless communication device;
determining whether voice recognition information associated with the wireless communication device is presently stored in the wireless system infrastructure based on the first identifier; and
in the event that voice recognition information associated with the wireless communication device is not presently stored in the wireless system infrastructure, requesting transmission of the voice recognition information stored in the memory of the wireless communication device.

14. The method of claim 13, further comprising the steps of:
in the event that voice recognition information associated with the wireless communication device is presently stored in the wireless system infrastructure,
comparing the second identifier to a third identifier associated with the voice recognition information presently stored in the wireless system infrastructure; and
requesting transmission of the voice recognition information stored in the memory of the wireless communication device in the event that the third identifier differs from the second identifier.

15. The method of claim 13, further comprising the steps of:
receiving the voice recognition information stored in the memory of the wireless communication device to produce received voice recognition information; and
storing the received voice recognition information in a memory of the wireless system infrastructure.

16. The method of claim 15, wherein the received voice recognition information comprises a context model.

17. The method of claim 16, wherein the context model includes at least one instruction that allows a user of the wireless communication device to perform at least one of the following functions:
a) control operation of the wireless communication device;
b) control operation of a remotely located electronic device;
c) retrieve information stored in the wireless communication device;
d) establish a communication in a wireless communication system; and
e) control operation of a voice recognition processor forming part of the wireless system infrastructure.

18. The method of claim 17, further comprising the steps of:
receiving a first data message from the wireless communication device, wherein the first data message includes an instruction of the at least one instruction;
determining the instruction contained in the first data message based on the received voice recognition information to produce a determined instruction; and
generating a second data message representative of the determined instruction to facilitate execution of the instruction.

19. A wireless communication device comprising:
a memory device that stores voice recognition information specific to a user of the wireless communication device, the voice recognition information being usable by a voice recognition processor of a wireless system infrastructure to provide voice recognition service to the wireless communication device; and
a transmitter, operably coupled to the memory device, that transmits the voice recognition information to the wireless system infrastructure for use by the voice recognition processor during operation of the wireless communication device.

20. The wireless communication device of claim 19, wherein the memory device comprises a memory device inserted into the wireless communication device by the user.

21. The wireless communication device of claim 19, further comprising:
a receiver that receives a request for the voice recognition information from the wireless system infrastructure; and
a processor, operably coupled to the receiver, the transmitter, and the memory device, that retrieves the voice recognition information from the memory device responsive to the request, prepares a data message containing the voice recognition information, and instructs the transmitter to transmit the data message to the wireless system infrastructure.

22. A wireless system infrastructure that provides voice recognition service, the wireless system infrastructure comprising:
a base transceiver site that receives, during a first time period, voice recognition information from a wireless communication device to produce received voice recognition information, wherein the received voice recognition information includes a context model, and that receives, during a second, later time period, a first data message from the wireless communication device containing an instruction forming part of the context model;
a memory device, operably coupled to the base transceiver site, that stores the received voice recognition information to produce stored voice recognition information; and
a voice recognition processor, operably coupled to the memory device and the base transceiver site, that generates a second data message representative of the instruction contained in the first data message based on the stored voice recognition information, the second data message being used to execute the instruction.

23. A memory device for use with a wireless communication device, the memory device comprising at least one memory location that stores voice recognition information associated with the wireless communication device, the voice recognition information including a context model and being used to provide voice recognition functionality to the wireless communication device.

24. The memory device of claim 23, wherein the memory device is insertable into the wireless communication device.

25. The memory device of claim 23, wherein the at least one memory location further stores an identifier associated with the voice recognition information.
